(19) United States
(12) Patent Application Publication
(10) Pub. No.: US 2026/0261369 A1
(43) Pub. Date: Sep. 3, 2026

(54) DISCONTINUOUS TRANSMISSION DETECTION FOR HARQ FEEDBACK

(71) Applicant: Telefonaktiebolaget LM Ericsson (publ), Stockholm (SE)

(72) Inventors: Qingchao LIU, Ottawa (CA); Xixian CHEN, Ottawa (CA)

(73) Assignee: Telefonaktiebolaget LM Ericsson (publ), Stockholm (SE)

(21) Appl. No.: 18/846,651

(22) PCT Filed: Apr. 11, 2022
(86) PCT No.: PCT/IB2022/053382

§ 371 Date: Sep. 12, 2024

(51) Int. Cl. H04L 1/1825; H04L 1/1812; H04W 76/28

(52) U.S. Cl. CPC H04L 1/1825; H04L 1/1816; H04W 76/28

(57) ABSTRACT

According to some embodiments, a method performed by a wireless device comprising: receiving a wireless channel; estimating a signal to interference and noise ratio (SINR) associated with the received wireless channel; determining whether the estimated SINR is below a discontinuous transmission (DTX) threshold; upon determining the estimated SINR is below the DTX threshold, terminating decoding of the received wireless channel; and upon determining the estimated SINR is above the DTX threshold, decoding the received wireless channel.

### TECHNICAL FIELD

Embodiments of the present disclosure are directed to wireless communications and, more particularly, to discontinuous transmission (DTX) detection for hybrid automatic repeat request (HARQ) feedback.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Hybrid automatic repeat request (HARQ) is an essential component of fifth generation (5G) new radio (NR) wireless networks. A gNB sends downlink control information (DCI) on a physical downlink control channel (PDCCH). The DCI carries scheduling information for uplink and downlink. The DCI provides a user equipment (UE) with the necessary information for proper reception and decoding of the downlink data on the physical downlink shared channel (PDSCH) as well as transmitting the uplink data and uplink control information (UCI) on physical uplink shared channel (PUSCH) or UCI on physical uplink control channel (PUCCH).

Each DCI is carried on one or multiple control channel elements (CCEs) depending on DCI length and the channel condition. The number of CCEs used is referred to as the CCE aggregation level, which may be 1, 2, 4, 8, or 16. All the CCEs for the same DCI carry the same information. For multiple CCEs, i.e., higher aggregation level, DCI payload is repeated to achieve lower code rate, which is needed if the UE is in poor radio frequency (RF) condition. A DCI is mapped to a PDCCH at the physical layer (PHY). The terms DCI and PDCCH may be used interchangeably herein when there is no confusion.

PDCCH link adaptation (LA) is used to choose an optimal CCE aggregation level for each DCI based on radio channel conditions measured and reported to a gNB as a channel quality indicator (CQI) by a UE. If the channel condition is good, i.e., for higher CQI, a fewer number of CCEs or a lower CCE aggregation level is used. Otherwise, for lower CQI, a higher number of CCEs or a high CCE aggregation level is used.

The number of available CCEs for each carrier and each slot is limited, and all the UEs share the limited CCEs. Therefore, the performance of PDCCH LA significantly impacts the performance of 5G radio access network (RAN), such as capacity. As an example, for voice over Internet Protocol (VoIP), PDCCH capacity is a critical limiting factor for VoIP capacity because the demand for DCIs is high. If the PDCCH LA is too aggressive, i.e., less CCEs are used for a UE to accommodate capacity, some UE may have more PDCCH decoding failures.

Then the UE cannot locate the related downlink data sent through PDSCH or uplink data granted at PUSCH, which results in significant throughput reduction and reduced user satisfaction level. On the other hand, if the LA is too conservative, fewer users can be accommodated by the PDCCH resources, resulting in a lower capacity.

To accommodate systematic errors in CQI/PMI reporting from the UE and to track faster changes in channel conditions, a PDCCH outer-loop adjustment is normally used to generate an outer-loop adjustment OL_ADJ that is added to the PDCCH signal to interference and noise ratio (SINR) estimation based on the CQI/PMI report. The overall estimated SINR based on CQI/PMI and outer-loop adjustment is used in determining the CCE aggregation level. The outer-loop adjustment is calculated based on the PDCCH transmission result, which is determined by the gNB. The transmission result could be a success, failure, or unknown (when the gNB cannot determine whether a PDCCH transmission is successful or not due to Third Generation Partnership Project (3GPP) standard limitation, it is referred to as an “unknown” state).

For each downlink transmission, the HARQ feedback result transmitted on either PUCCH or PUSCH may be: (a) PDSCH ACK, when the UE successfully decodes both PDCCH and PDSCH, and sends ACK to gNB; (b) PDSCH NAK, when the UE successfully decodes PDCCH but fails to decode PDSCH and sends NAK to gNB; or (c) DTX (Discontinuous Transmission), when the UE fails to decode PDCCH and does not send any feedback to gNB.

There are five different formats of PUCCH. Which format is used is determined by how many bits of information are to be carried and how many symbols are assigned, as summarized in Table 1 (reproduced from 3GPP 38.211 Table 6.3.2.1-1 PUCCH formats).

TABLE 1

| Format | Length of | Number | |
|---|---|---|---|
| Types | Symbols | of bits | Descriptions (based on 38.300-5.3.3) |
| Format 0 | 1~2 | <=2 | Short PUCCH. |
| | | | with UE multiplexing in the |
| | | | same PRB. |
| | | | Based on sequence selection. |
| Format 1 | 4~14 | <=2 | Long PUCCH. |
| | | | with multiplexing in the |
| | | | same PRB. |
| | | | time-multiplex the UCI and DMRS |
| Format 2 | 1~2 | >2 | Short PUCCH. |
| | | | with no multiplexing in the |
| | | | same PRB. |
| | | | frequency multiplexes UCI and DMRS |
| Format 3 | 4~14 | >2 | Long PUCCH. |
| | | | with large UCI payloads and with |
| | | | no multiplexing capacity in the |
| | | | same PRB |
| | | | time-multiplex the UCI and DMRS |
| Format 4 | 4~14 | >2 | Long PUCCH. |
| | | | with moderate UCI payloads and with |
| | | | some multiplexing capacity (max 4 UE) |
| | | | in the same PRB. |

The following UCI encoders exist depending on the number of its information bits.

TABLE 2

| Number of | |
|---|---|
| information bits | Encoder |
| 1 | Table 5.3.3.1-1 of 38.212 |
| 2 | Table 5.3.3.2-1 of 38.212 |

| | | |
|---|---|---|
| 3 to 11 | bits | Section 5.3.3.3 R-M block encoder in 38 212 |
| >=12 | bits | Section 5.3.1 Polar encoder in 38 212 |

There currently exist certain challenges. For example, based on the 3GPP standard, when the number of HARQ bits is between 12 and 19, only 6 CRC bits are used for the Polar encoder. The Polar decoder performance depends on the number of parallel list decoders. For example, List8 roughly doubles the Ack False (DTX to ACK) rate compared to List4 because it doubles the number of lists. Ack False probability is inverse-exponentially proportional to CRC length and proportionally to the list size.

FIG. 1 is a graph illustrating the blind decoding performance without DTX detection for 12 HARQ bits with 1, 2, 4, and 8 receiving branches. The ACK False (DTX to ACK) rates are from 3.1% to more than 6%, much higher than the 3GPP specification (1%).

FIG. 2 illustrates HARQ ACK false rates for 12 to 20 HARQ bits with 4 receiving branches. The higher Ack False decoding rate will trigger more HARQ and radio link control (RLC) retransmissions, which will have a significant impact on the system performance in terms of the transmitted data rates and delays. It will also have a negative effect on the performance of PDCCH link adaptation.

### SUMMARY

Based on the description above, certain challenges currently exist with discontinuous transmission (DTX) detection for hybrid automatic repeat request (HARQ) feedback. For example, as described above for the HARQ bits in a range from 12 to 19 with 6 CRC bits, it is hard to meet the 1% target for Ack False (DTX to ACK) rate without the DTX detection algorithm.

Certain aspects of the present disclosure and their embodiments may provide solutions to these or other challenges. For example, some embodiments effectively decode physical uplink control channel (PUCCH) and resolve false cyclic redundancy check (CRC) detection when the number of CRC bits is 6, which is used for uplink control information (UCI) information bits ranging from 12 to 19. Some embodiments use the decoding results to do physical downlink control channel (PDCCH) link adaptation.

Some embodiments perform DTX detection before Polar decoding. The DTX detection algorithm is based on a signal to interference and noise ratio (SINR) value estimated at the receiver. Based on the configured number of the receiver branches, particular embodiments use its corresponding DTX threshold to determine whether the decoded result is DTX or not. If the decoding result is not DTX, the Polar decoding process is then performed. If the gNB decodes the PUCCH with CRC check passed, it means that the UE successfully decoded the PDCCH, and the decoding result can be used by the gNB for further processing. If the CRC check fails during the decoding process, the decoding result is classified as “unknown.” The decoding DTX result may also be used to do the outer-loop adjustment of the PDCCH signal to interference and noise ratio (SINR) for PDCCH link adaptation.

According to some embodiments, a method performed by a wireless device comprises: receiving a wireless channel; estimating a SINR associated with the received wireless channel; and determining whether the estimated SINR is below a DTX threshold. Upon determining the estimated SINR is below the DTX threshold, the method comprises terminating decoding of the received wireless channel. Upon determining the estimated SINR is above the DTX threshold, the method comprises decoding (e.g., Polar decoding) the received wireless channel.

In particular embodiments, upon unsuccessful decoding of the received wireless channel, the method comprises retransmitting a data packet with a same hybrid automatic repeat request (HARQ) redundancy version as a previous transmission of the data packet. Upon successful decoding of the received wireless channel, the method comprises performing HARQ operations according to HARQ feedback indicators (e.g., ACK or NACK) in the decoded wireless channel.

In particular embodiments, the DTX threshold is based on a number of receive chains of the wireless receiver and/or whether the wireless receiver is using maximum ratio combining (MRC) or interference reduction combining (IRC).

In particular embodiments, upon determining the estimated SINR is below the DTX threshold, the method comprises performing link adaptation by decrementing a link adaptation parameter. Upon unsuccessful decoding of the received wireless channel, the method comprises performing link adaptation by decrementing a link adaptation parameter by a scaling factor. Upon successful decoding of the received wireless channel, the method comprises performing link adaptation by incrementing a link adaptation parameter.

In particular embodiments, the wireless receiver comprises a network node, and the received wireless channel comprises one of a PUCCH and a PUSCH. In particular embodiments, the wireless receiver comprises a user equipment and the received wireless channel comprises one of a PDCCH and a PBCH.

According to some embodiments, a wireless device comprises processing circuitry operable to perform any of the wireless device methods described above.

Also disclosed is a computer program product comprising a non-transitory computer readable medium storing computer readable program code, the computer readable program code operable, when executed by processing circuitry to perform any of the methods performed by the wireless device described above.

Certain embodiments may provide one or more of the following technical advantages. For example, some embodiments guarantee that the ACK false rate is less than 1%, meeting the 3GPP standard. Some embodiments provide more accurate outer loop adjustment for PDCCH link adaptation.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a graph illustrating the blind decoding performance without discontinuous transmission (DTX) detection for 12 hybrid automatic repeat request (HARQ) bits with 1, 2, 4, and 8 receiving branches;

FIG. 2 illustrates HARQ ACK false rates for 12 to 20 HARQ bits with 4 receiving branches;

FIG. 3 is a graph illustrating DTX to Ack false detection simulation results after applying the DTX thresholds;

FIG. 4 is a graph used to tune DTX thresholds, according to particular embodiments.

FIG. 5 is a block diagram illustrating an example wireless network;

FIG. 6 illustrates an example user equipment, according to certain embodiments;

FIG. 7 is flowchart illustrating an example method in a wireless device, according to certain embodiments;

FIG. 8 is flowchart illustrating an example method in a network node, according to certain embodiments; and

FIG. 9 illustrates a schematic block diagram of a wireless device and a network node in a wireless network, according to certain embodiments.

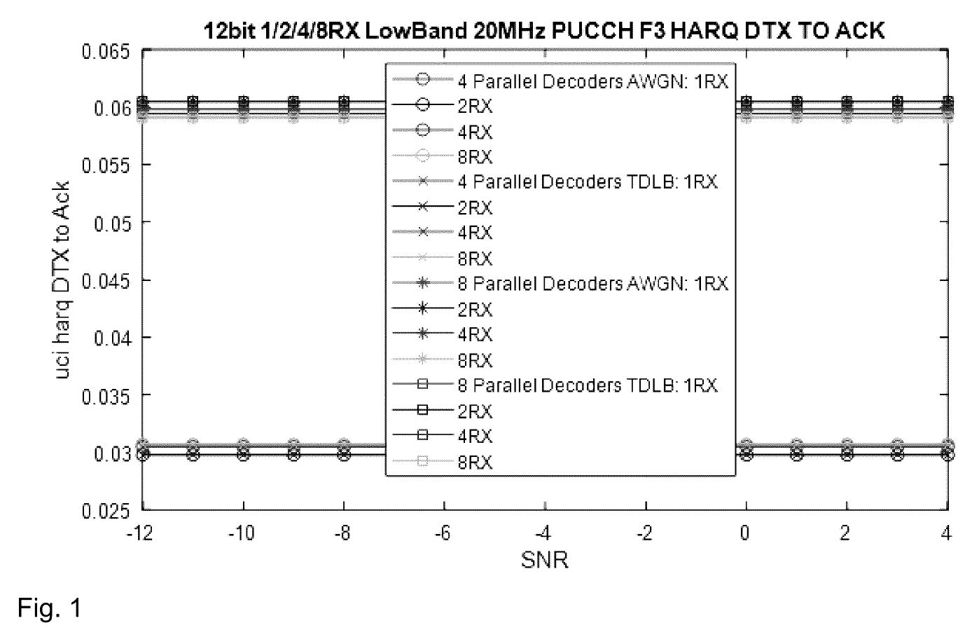

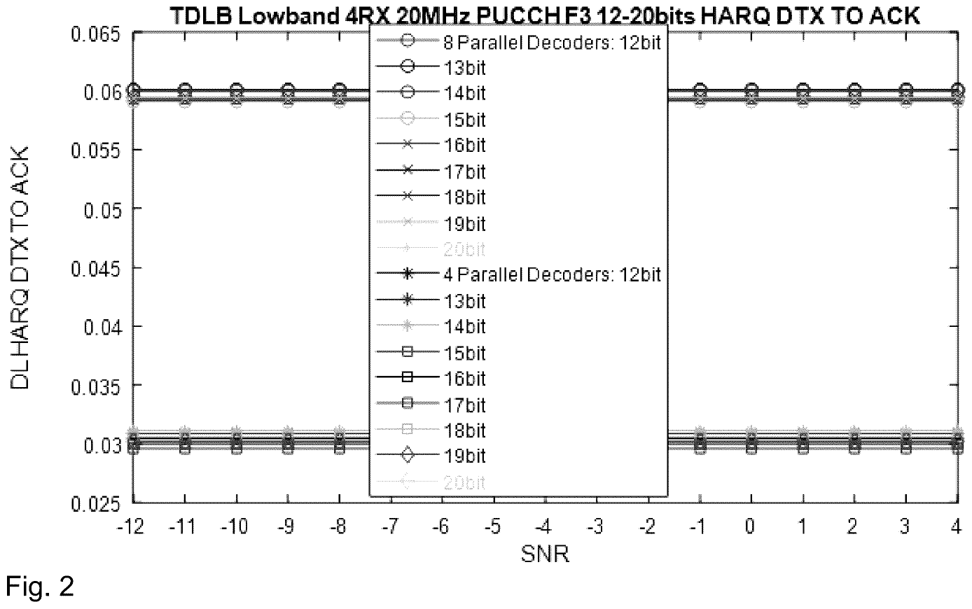

### DETAILED DESCRIPTION

As described above, certain challenges currently exist with discontinuous transmission (DTX) detection for hybrid automatic repeat request (HARQ) feedback. For example, as described above for the HARQ bits in a range from 12 to 19 with 6 CRC bits, it is hard to meet the 1% target for Ack False (DTX to ACK) rate without the DTX detection algorithm.

Certain aspects of the present disclosure and their embodiments may provide solutions to these or other challenges. For example, some embodiments perform DTX detection before Polar decoding. The DTX detection algorithm is based on the signal to interference and noise ratio (SINR) value estimated at the receiver. Based on the configured number of the receiver branches, particular embodiments use its corresponding DTX threshold to determine whether the decoded result is DTX or not.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Based on simulation results, to achieve a 1% Ack false and 1% Ack missed and 0.1% Nack to Ack, the minimum required SINRs at the receiver are shown in Table 3 for one, two, four, and eight receiver branches with maximum ratio combining (MRC) and interference reduction combining (IRC) modes, respectively.

TABLE 3
DTX threshold table for PUCCH Decoding

DTX Thresholds (the minimum required SINRs)

| Mode | 1RX | 2RX | 4RX | 8Rx |
|---|---|---|---|---|
| MRC | −11.0 dB | −8.5 dB | −6.0 dB | −3.3 dB |
| IRC | −11.0 dB | −8.2 dB | −5.2 dB | −1.4 dB |

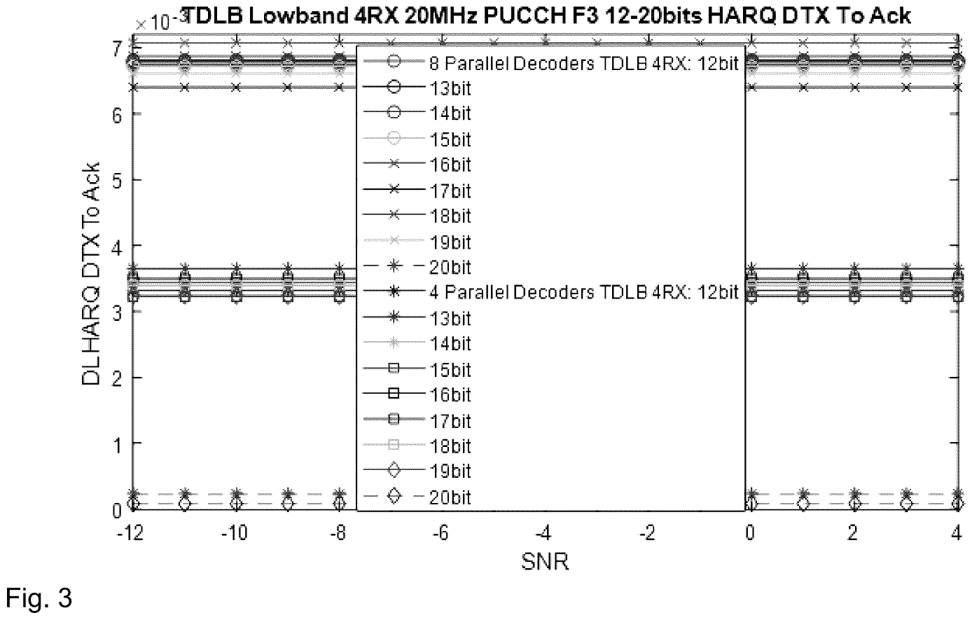

FIG. 3 is a graph illustrating DTX to Ack false detection simulation results after applying the DTX thresholds. The simulation was performed based on Table 3. The graph illustrates that the DTX to ACK false detection rate will meet the requirement of 1%, and Ack missed of 1%, and Nack to Ack 0.1%, meeting 3GPP standard.

Particular embodiments use the following procedure to decode a physical uplink control channel (PUCCH). At step 1, a network node estimates the receiving SINR of the PUCCH. At step 2, the network node compares the estimated SINR with a DTX threshold (dtxThreshold). For example, based on Table 3 if the receiver has two branches and using MRC mode, the dtxThreshold is −8.5 dB. If the receiver has four branches using IRC mode, the dtxThreshold is −5.2 dB.

If the estimated SINR is below dtxThreshold, particular embodiments consider it DTX, which means that the UE failed to decode the physical downlink control channel (PDCCH) and did not send the HARQ feedback to the gNB. If the estimated SINR is above dtxThreshold and the gNB decodes the PUCCH with CRC check passed, particular embodiments consider the HARQ feedback bits as decoded successfully. Otherwise, the procedure proceeds to step 3.

At step 3, because the estimated SINR is above dtxThreshold, but the gNB failed to decode the PUCCH (CRC check failed), the decoding results are classified as “unknown” because the gNB could not determine the status of HARQ feedback due to 3GPP standard limitation.

The procedure above may guarantee that the ACK false rate is less than 1%.

When the PUCCH decoding result is classified as DTX, it means that the UE failed to decode the PDCCH and did not send the HARQ feedback to the gNB. As a result, the gNB retransmits the original data packet to the UE with redundant version 0. If the decoding result is classified as “unknown,” the gNB could not determine whether the UE sent the HARQ feedback or not. To be safe, the gNB can treat it as DTX and retransmit the original data packet to the UE with the same previous redundancy version.

If the decoding result is classified as successful, it means that the UE successfully decoded the PDCCH and sent its corresponding HARQ feedback. Based on the decoding result, the gNB may perform the following process. If the HARQ feedback is NACK, its corresponding data packet will be retransmitted with a different redundant version. If it is ACK, the gNB knows that the UE successfully received the data packet and will remove it from the downlink transmit buffer.

The decoding result may also be used to do the outer-loop adjustment of PDCCH SINR for PDCCH link adaptation. If the previous transmission HARQ feedback is successfully decoded with CRC checking passed, it means that the UE has successfully decoded the PDCCH. The PDCCH SINR is increased by an amount defined as UP_STEP. The SINR adjustment is: OL_ADJ+=UP_STEP.

If the previous transmission HARQ feedback is classified as a DTX, the SINR adjustment is decreased by DOWN_STEP. The SINR adjustment is: OL_ADJ-=DOWN_STEP.

If gNB doesn't know whether the previous transmission is successful or not, i.e., “unknown”, the SINR adjustment is decreased by a fraction of DOWN_STEP, i.e., α. The SINR adjustment is: OL_ADJ-=α*DOWN_STEP.

The ratio of the UP_STEP and DOWN_STEP may be determined based on the desired block error rate (BLER) target in percentage (or the PDCCH transmission failure rate): DOWN_STEP/UP_STEP=100/BLER_TARGET−1.

The DOWN_STEP value may be tuned to have the desired outer-loop convergence speed. The parameter α may be a tuning parameter with values between 0 and 1. BLER_TARGET may be pre-determined, e.g., 1%.

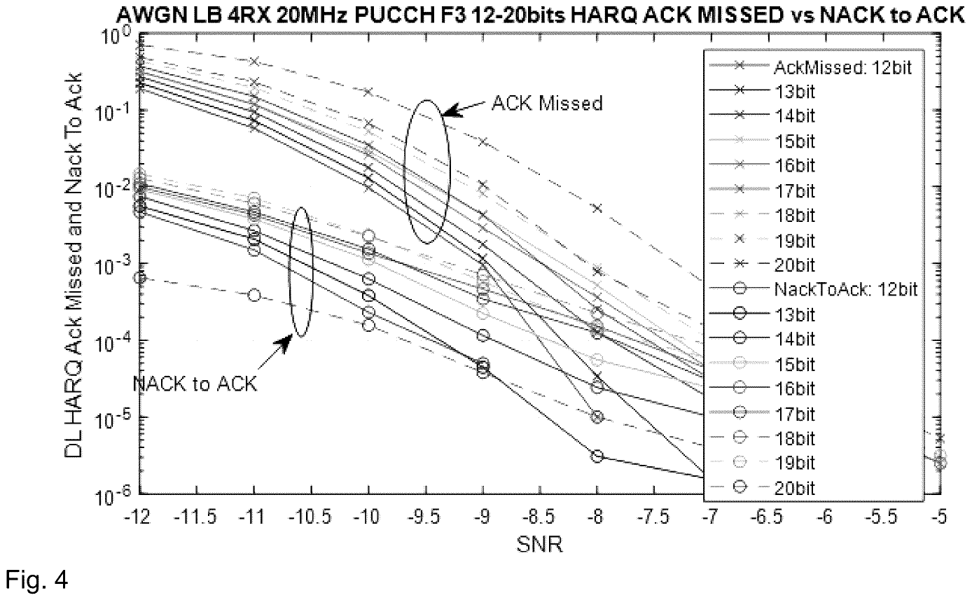

FIG. 4 is a graph used to tune DTX thresholds, according to particular embodiments. The DTX thresholds may be tuned to meet DTX to Ack requirements of 1% and also do not overly compromise for Ack Missed 1% target and 0.1% for Nack to Ack target.

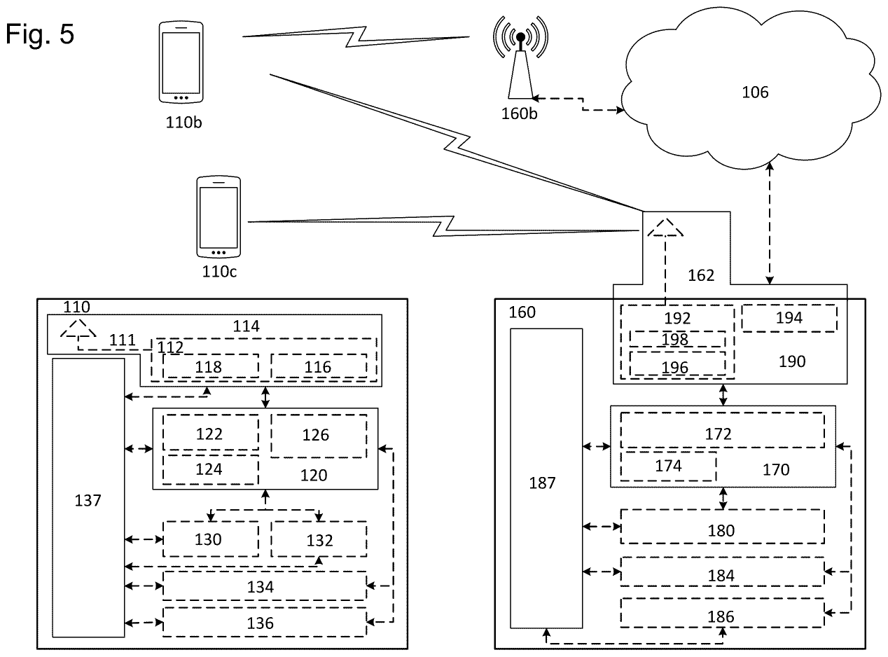

FIG. 5 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, network node 160 includes processing circuitry 170, device readable medium 180, interface 190, auxiliary equipment 184, power source 186, power circuitry 187, and antenna 162. Although network node 160 illustrated in the example wireless network of FIG. 5 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 5 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 5. For simplicity, the wireless network of FIG. 5 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

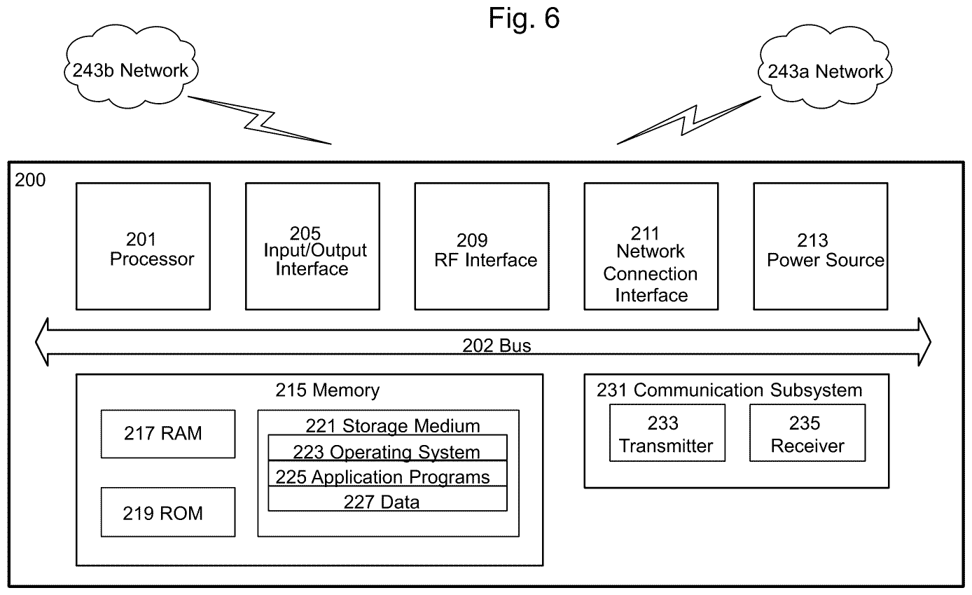

FIG. 6 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 6, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 6 is a UE, the components discussed herein are equally applicable to a WD, and vice-versa.

In FIG. 6, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 6, or only a subset of the components. The level of integration between the components may vary from one UE to another UE. Further, certain UEs may contain multiple instances of a component, such as multiple processors, memories, transceivers, transmitters, receivers, etc. In FIG. 6, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 6, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 6, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

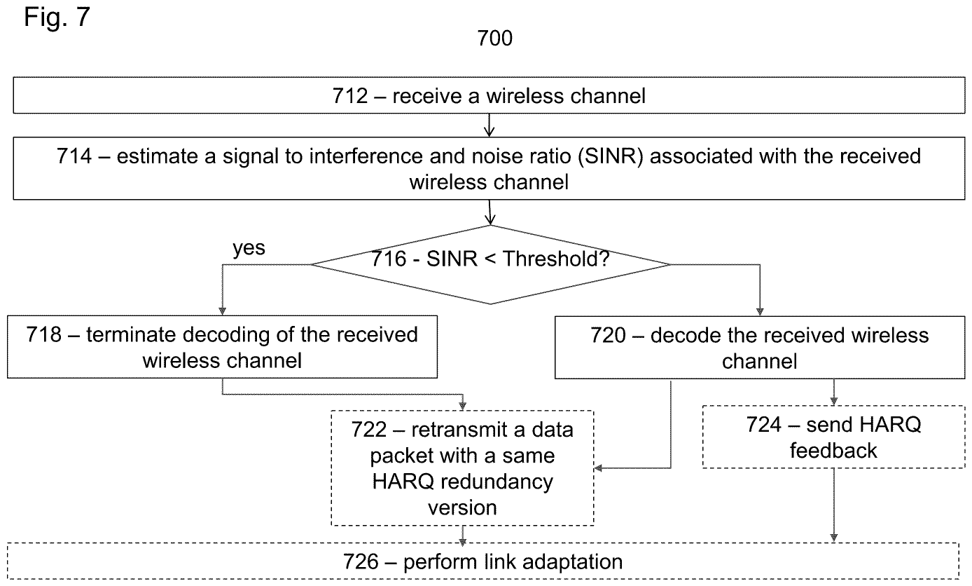

FIG. 7 is a flowchart illustrating an example method in a wireless receiver, according to certain embodiments. In particular embodiments, one or more steps of FIG. 7 may be performed by wireless device 110 or network node 160 described with respect to FIG. 5.

The method may begin at step 712, where the wireless receiver (e.g., wireless device 110 or network node 160) receives a wireless channel. For example, the wireless receiver may comprise a network node and the wireless channel may comprise one of a PUCCH and a PUSCH. The wireless receiver may comprise a user equipment and the wireless channel may comprise one of a PDCCH and a PBCH.

At step 714, prior to decoding, the wireless device estimates a SINR associated with the received wireless channel, and at step 716 determines whether the estimated SINR is below a DTX threshold.

In particular embodiments, the DTX threshold is based on a number of receive chains of the wireless receiver and/or whether the wireless receiver is using maximum ratio combining (MRC) or interference reduction combining (IRC). In some embodiments, different thresholds may be used for uplink and downlink.

Upon determining the estimated SINR is below the DTX threshold, the method continues to step 718, where the wireless receiver terminates decoding of the received wireless channel. Upon determining the estimated SINR is above the DTX threshold, the method continues to step 720, where the wireless receiver decodes (e.g., Polar decodes) the received wireless channel.

Upon unsuccessful decoding of the received wireless channel or the estimated SINR is below the DTX threshold, the method continues to step 722, where the wireless receiver retransmits a data packet with a same HARQ redundancy version as a previous transmission of the data packet. Upon successful decoding of the received wireless channel, the method continues to step 724, where the wireless receiver performs HARQ operations according to HARQ feedback indicators (e.g., ACK or NACK) in the decoded wireless channel.

The wireless receiver may perform link adaptation based on the results of the previous steps. At step 726, the wireless receiver performs link adaption according to any of the embodiments and examples described above. For example, in particular embodiments, upon determining the estimated SINR is below the DTX threshold, the wireless receiver performs link adaptation by decrementing a link adaptation parameter (e.g., SINR adjustment decreased by DOWN_STEP). Upon unsuccessful decoding of the received wireless channel, the method comprises performing link adaptation by decrementing a link adaptation parameter by a scaling factor (e.g., SINR adjustment decreased by α*DOWN_STEP). Upon successful decoding of the received wireless channel, the method comprises performing link adaptation by incrementing a link adaptation parameter (e.g., SINR adjustment increased by UP_STEP).

Modifications, additions, or omissions may be made to method 700 of FIG. 7. Additionally, one or more steps in the method of FIG. 7 may be performed in parallel or in any suitable order.

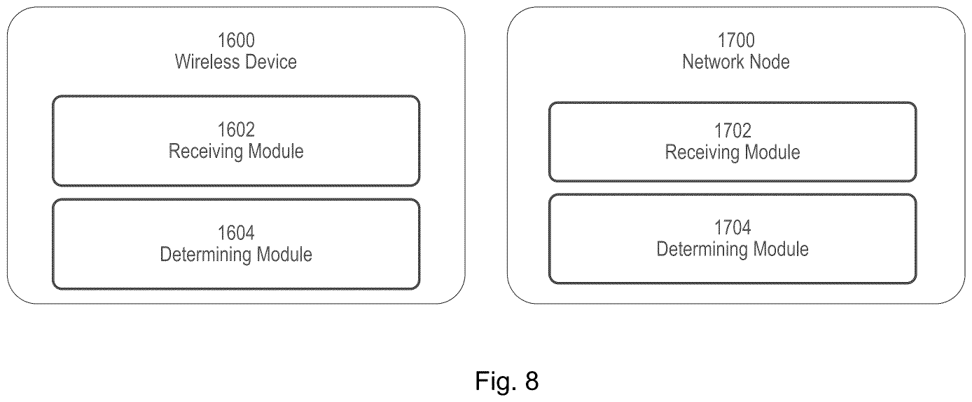

FIG. 8 illustrates a schematic block diagram of two apparatuses in a wireless network (for example, the wireless network illustrated in FIG. 5). The apparatuses include a wireless device and a network node (e.g., wireless device 110 and network node 160 illustrated in FIG. 5). Apparatuses 1600 and 1700 are operable to carry out the example methods described with reference to FIG. 7, and possibly any other processes or methods disclosed herein. It is also to be understood that the method of FIG. 7 is not necessarily carried out solely by apparatuses 1600 and/or 1700. At least some operations of the method may be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause receiving module 1602, determining module 1604, and any other suitable units of apparatus 1600 to perform corresponding functions according one or more embodiments of the present disclosure. Similarly, the processing circuitry described above may be used to cause receiving module 1702, determining module 1704, and any other suitable units of apparatus 1700 to perform corresponding functions according one or more embodiments of the present disclosure.

As illustrated in FIG. 8, apparatus 1600 includes receiving module 1602 configured to receive a wireless channel according to any of the embodiments and examples described herein. Determining module 1604 is configured to determine whether an SINR of the received channel is below a DTX threshold and decode the wireless channel according to any of the embodiments and examples described herein.

As illustrated in FIG. 8, apparatus 1700 includes receiving module 1702 configured to receive a wireless channel according to any of the embodiments and examples described herein. Determining module 1704 is configured to whether an SINR of the received channel is below a DTX threshold and decode the wireless channel according to any of the embodiments and examples described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a wireless receiver, the method comprising:
receiving a wireless channel;
estimating a signal to interference and noise ratio (SINR) associated with the received wireless channel;
determining whether the estimated SINR is below a discontinuous transmission (DTX) threshold, wherein the DTX threshold is based on:
a number of receive chains of the wireless receiver; or
whether the wireless receiver is using maximum ratio combining (MRC) or interference reduction combining (IRC);
upon determining the estimated SINR is below the DTX threshold, terminating decoding of the received wireless channel;
upon determining the estimated SINR is above the DTX threshold, decoding the received wireless channel; and
performing link adaptation by incrementing or decrementing a link adaptation parameter.

2. The method of claim 1, further comprising, upon unsuccessful decoding of the received wireless channel or the estimated SINR is below the DTX threshold, retransmitting a data packet with a same hybrid automatic repeat request (HARQ) redundancy version as a previous transmission of the data packet.

3. The method of claim 1, further comprising, upon successful decoding of the received wireless channel, performing HARQ operations according to HARQ feedback indicators in the decoded wireless channel.

4. The method of claim 1, wherein the DTX threshold is based on a number of receive chains of the wireless receiver.

5. The method of claim 1, wherein the DTX threshold is based on whether the wireless receiver is using maximum ratio combining (MRC) or interference reduction combining (IRC).

6. The method of claim 1, further comprising, upon determining the estimated SINR is below the DTX threshold, performing link adaptation by decrementing the link adaptation parameter.

7. The method of claim 1, further comprising, upon unsuccessful decoding of the received wireless channel, performing link adaptation by decrementing the link adaptation parameter by a scaling factor.

8. The method of claim 1, further comprising, upon successful decoding of the received wireless channel, performing link adaptation by incrementing the link adaptation parameter.

9. The method of claim 1, wherein the wireless receiver comprises a network node, wherein the received wireless channel comprises one of a physical uplink control channel (PUCCH) and a physical uplink shared channel (PUSCH).

10. (canceled)

11. The method of claim 1, wherein the wireless receiver comprises a user equipment, wherein the received wireless channel comprises one of a physical downlink control channel (PDCCH) and a physical broadcast channel (PBCH).

12. (canceled)

13. The method of claim 1, wherein decoding the received wireless channel comprises Polar decoding.

14. A wireless receiver comprising processing circuitry operable to:
receive a wireless channel;
estimate a signal to interference and noise ratio (SINR) associated with the received wireless channel;
determine whether the estimated SINR is below a discontinuous transmission (DTX) threshold, wherein the DTX threshold is based on:
a number of receive chains of the wireless receiver; or
whether the wireless receiver is using maximum ratio combining (MRC) or interference reduction combining (IRC);
upon determining the estimated SINR is below the DTX threshold, terminate decoding of the received wireless channel;
upon determining the estimated SINR is above the DTX threshold, decode the received wireless channel; and
perform link adaptation by incrementing or decrementing a link adaptation parameter.

15. The wireless receiver of claim 14, the processing circuitry further operable to, upon unsuccessful decoding of the received wireless channel or the estimated SINR is below the DTX threshold, retransmit a data packet with a same hybrid automatic repeat request (HARQ) redundancy version as a previous transmission of the data packet.

16. The wireless receiver of claim 14, the processing circuitry further operable to, upon successful decoding of the received wireless channel, perform HARQ operations according to HARQ feedback indicators in the decoded wireless channel.

17-18. (canceled)

19. The wireless receiver of claim 14, further comprising, upon determining the estimated SINR is below the DTX threshold, performing link adaptation by decrementing the link adaptation parameter.

20. The wireless receiver of claim 14, the processing circuitry further operable to, upon unsuccessful decoding of the received wireless channel, perform link adaptation by decrementing the link adaptation parameter by a scaling factor.

21. The wireless receiver of claim 14, the processing circuitry further operable to, upon successful decoding of the received wireless channel, perform link adaptation by incrementing the link adaptation parameter.

22. The wireless receiver of claim 14, wherein the wireless receiver comprises a network node, wherein the received wireless channel comprises one of a physical uplink control channel (PUCCH) and a physical uplink shared channel (PUSCH).

23. (canceled)

24. The wireless receiver of claim 14, wherein the wireless receiver comprises a user equipment, wherein the received wireless channel comprises one of a physical downlink control channel (PDCCH) and a physical broadcast channel (PBCH).

25. (canceled)

26. The wireless receiver of claim 14, wherein decoding the received wireless channel comprises Polar decoding.
